(19) United States
(12) Patent Application Publication
(10) Pub. No.: US 2014/0219088 A1
(43) Pub. Date: Aug. 7, 2014

(54) QUALITY OF EXPERIENCE ENHANCEMENTS OVER WIRELESS NETWORKS

(71) Applicants: Ozgur Oyman, San Jose, CA (US); Xintian E. Lin, Palo Alto, CA (US)

(72) Inventors: Ozgur Oyman, San Jose, CA (US); Xintian E. Lin, Palo Alto, CA (US)

(21) Appl. No.: 13/993,417

(22) PCT Filed: Sep. 30, 2011
(86) PCT No.: PCT/US11/54406

§ 371 Date: Apr. 11, 2014

(51) Int. Cl. H04W 28/24

(52) U.S. Cl. CPC H04W 28/24
USPC 370/231

(57) ABSTRACT

Systems and methods for providing content-aware adaptation of multimedia communications in wireless networks to ensure Quality of Experience (QoE) of the content transmitted by the multimedia communications are generally disclosed herein. One example embodiment includes adaptive streaming optimization techniques, such as the exchanging of application-layer parameters used to establish network connectivity settings and implement an appropriate QoE for applications communicating within the wireless network. Example embodiments may also determine and implement Quality of Service (QoS) parameters for the wireless network and other connected networks based on the application-layer parameters. Such application-layer parameters may include receiver display capabilities and multimedia-specific parameters. These techniques may be used in connection with, for example, the transmission of real-time multimedia content, such as multimedia content communicated wirelessly from a computing device using a Wireless Display (WiDi) transmission standard.

### TECHNICAL FIELD

Embodiments pertain to wireless communications. Some embodiments relate to the use of wireless multimedia communications, and Quality of Experience (QoE) techniques implemented within wireless networks and services.

### BACKGROUND

In wireless multimedia communications, various generic cross-layer design methodologies are used to optimize user QoE and increase the service capacity for the network communications. Quality degradation is generally caused by factors such as high distortion levels, limited bandwidth, excessive delay, power constraints, and computational complexity limitation.

Some user QoE optimization for multimedia services implement resource management strategies at the lower layers of network communications (e.g., the PHY, MAC, network, and transport layers) by considering the specific characteristics of the applications. In many cases, however, the PHY/MAC/NET layers in existing networks remain agnostic of dynamically varying application-layer requirements and characteristics, and only aim to optimize link quality subject to certain target Quality of Service (QoS) requirements.

Implemented QoS classes and associated service attributes generally do not accommodate QoE-related metrics for application-level multimedia processing, nor are multimedia streams generally prioritized or adapted in a content-aware fashion to optimize QoE. Further, networks typically do not pass any content-specific information regarding the multimedia processing at the codec to the wireless network, or otherwise enable cross-layer coordination capabilities.

There are general needs for improved methods of optimizing QoE for multimedia content service flows. There are also general needs for improved methods of establishing and operating adaptive streaming services over wireless networks.

### BRIEF DESCRIPTION OF THE DRAWINGS

FIG. 1 illustrates an adaptive streaming client architecture used in accordance with example embodiments;

FIG. 2 illustrates a QoS-aware network architecture for implementing adaptive streaming according to an example embodiment;

FIG. 3 illustrates a cross-layer adaptive streaming client adaptation configuration used in accordance with example embodiments;

FIG. 4 illustrates a video streaming optimization configuration provided to multiple video receivers according to one example embodiment;

FIG. 5 illustrates a method for performing a QoE optimization procedure with video streaming according to one example embodiment;

FIG. 6 illustrates a messaging and channel access configuration for streaming video from multiple sources according to one example embodiment; and

FIG. 7 illustrates a method for optimizing adaptive streaming network communications at a plurality of network levels according to one example embodiment.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Several of the embodiments described herein provide techniques for QoE-driven cross-layer optimization of network communications, such as in wireless networks enabling the distribution of multimedia content. In particular, some example embodiments include the configuration and use of a cross-layer optimized (and QoE-driven) client adaptation architecture to configure network communication parameters. These communication parameters may include various data, video, radio, network, and transport level parameters for implementing QoE with multimedia streaming services, such as Real Time Streaming Protocol (RTSP)-based or Dynamic Adaptive Streaming over HTTP (DASH)/HTTP-based adaptive streaming services.

QoE differs in various respects from QoS, and therefore is not fully addressed by existing QoS techniques implemented within network communication architectures. QoS generally provides mechanisms to ensure that data is communicated between two points (and prioritized, as appropriate) to provide network performance with minimal packet loss, bit rate, jitter, and latency. QoE, in contrast, generally implements mechanisms relating to the quality of the data itself being transferred. Thus, in multimedia settings, QoE may relate to quality of audio or video being played back to a user, which may be unsatisfactory even if the QoS for delivery of the corresponding audio or video data is satisfactory.

Implementing QoS standards within network configurations cannot ensure a satisfactory QoE, because QoS does not factor application requirements or otherwise operate in an application-aware manner (especially for delivery of multimedia content in wireless network settings). For example, in some QoS architectures supporting adaptive streaming services, the target QoS parameters for the core network and radio access network may be derived independently of multimedia-specific application layer parameters for multimedia streaming services, receiver device/display capabilities, or physical link conditions.

In accordance with the embodiments described herein, QoE-driven cross-layer optimization for multimedia communications may be provided through various resource management strategies at lower networking model layers (e.g., the PHY, MAC, network, and transport layers) by considering the specific characteristics of video and multimedia applications. QoE optimization may also be implemented by adapting video compression and streaming algorithms after taking into account the mechanisms provided by the lower layers for error control and resource allocation. For example, in connection with streaming multimedia communications, two of the capabilities enabled by cross-layer optimizations include:

(1) PHY/MAC/NET layer-aware content adaptation at the codec level, using adaptation parameters such as bit rate, resolution, frame rate, and the like, to enable a streaming service to adapt its content characteristics to varying network conditions (e.g., changing resource availability, or the time-varying nature of the wireless channel). Various content adaption strategies are performed to ensure the highest possible QoE while maintaining interruption-free playback of the multimedia. This capability is known as “adaptive streaming”.

(2) Application-aware PHY/MAC/NET layer adaptation at the radio and network levels in order to perform PHY/MAC/NET layer functions such as link adaptation and resource allocation. This may be used to exploit knowledge of various application-layer attributes associated with the video content and service. For example, knowledge of the rate-distortion characteristics of the video stream can allow for performing distortion-aware channel access prioritization at the PHY/MAC/NET layer to enhance video quality.

Both of these optimizations in combination are not fully realized with existing network techniques. This occurs in part because the PHY/MAC/NET layers in most networks only attempt to optimize link quality to QoS requirements, with use of parameters such as throughput, latency/jitter, packet error/loss rate, and so forth. Also, due to layer independence and separation, and the limitations of QoS as previously described, existing QoS classes and associated service attributes do not accommodate QoE-related metrics for application-level multimedia processing and prioritize the multimedia streams in a content-aware fashion.

Further, existing network configurations generally do not pass content-specific information (e.g., rate-distortion characteristics of the video stream, associated video quality metrics, and the like) regarding the multimedia processing at the codec (application) level to wireless networks. In this context, new cross-layer coordination capabilities and signaling mechanisms may be used to enable exchanging application-level information for QoE-aware radio and wireless multimedia network adaptation, and for resource management for one or more service flows.

The various embodiments described herein disclose techniques and configurations that provide adaptive services for wireless networks to enable such content-awareness and enhanced QoE. Both conversational and streaming services may be enhanced using the techniques described herein. In addition, the techniques described herein are applicable for unicast, multicast and broadcast multimedia delivery methods. Moreover, the proposed techniques are also applicable in heterogeneous environments that require delivery of multimedia content such as video over multiple air interfaces.

Aspects of the present disclosure provide techniques relevant to the transmission and receipt of wireless networking communications, and specifically wireless communication systems and protocols adapted for multimedia content communications. An example multimedia networking configuration that may be enhanced in connection with the presently described techniques is known under the names of “WirelessHD”, “wireless display”, or simply “WiDi”, with one example WiDi implementation marketed as “INTEL® Wireless Display”. WiDi relies on local peer-to-peer (P2P) wireless connectivity over a Wireless Local Area Network (WLAN) or Wireless Personal Area Network (WPAN)-based air interface (e.g., Wi-Fi P2P, Wi-Fi Alliance Wi-Fi Display, WiDi Direct, myWi-Fi, 60 GHz technology, and the like) to transfer data between multimedia devices, such as a computer and a television.

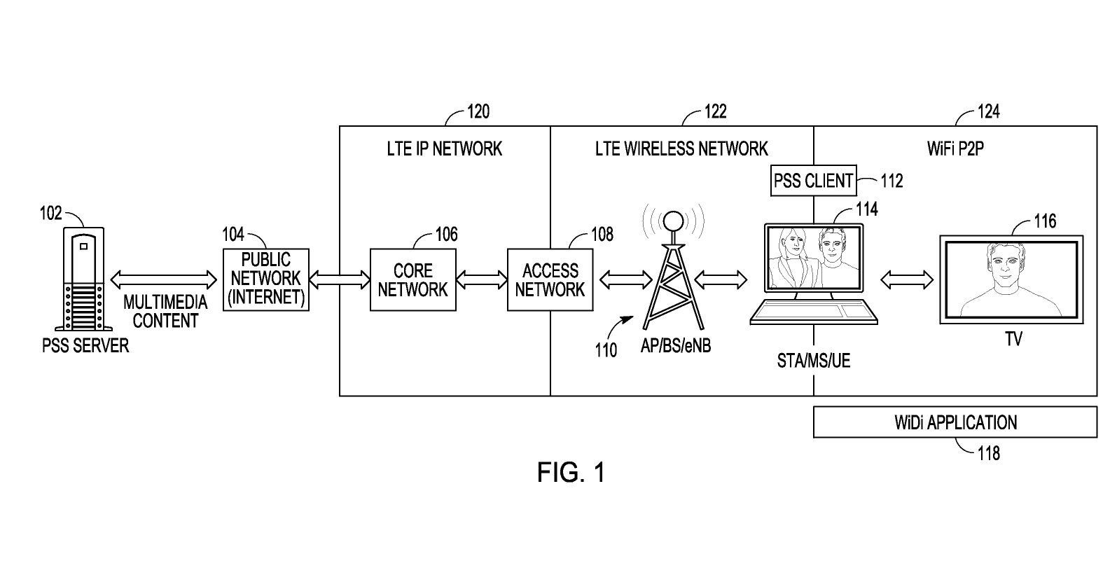

For example, FIG. 1 depicts an example configuration of an adaptive streaming network architecture configured to deliver multimedia content via a packet-switched streaming service (PSS) from a PSS server 102 to a PSS client 112. The following illustrates multimedia content transmission via a 3GPP Long Term Evolution (LTE) or Long Term Evolution Advanced (LTE-A) network configuration, although any of a number of wireless network standards and protocols may be similarly configured for use in streaming network architecture.

The multimedia content data is delivered from the PSS server 102 and the public network 104 (e.g., the Internet) to a core network 106, and transmitted from the core network 106 through an access network 108. The core network 106 and access network 108 exist within the LTE IP network 120, e.g., an internal IP network maintained by a telecommunications provider. The access network 108 provides network connectivity between the core network 106 and the wirelessly transmitting access point/base station/eNodeB 110 within a LTE wireless network 122, e.g., a wireless network provided by a telecommunications provider.

Thus, the multimedia content data is transmitted from the access network 108 to the base station/eNodeB 110, broadcasted via a wireless communication (e.g., a cellular data transmission) from the base station/eNodeB 110 via the LTE wireless network 122, and received at a mobile station (MS)/user equipment (UE) at the receiving computing device 114 for processing by the PSS client 112.

The PSS client 112 in turn may use a WiFi P2P network 124 to further transmit the streaming multimedia content onto another device, such as the user's television 116. This final transmission to the television 116 via the WiFi P2P network 124 may involve the use of a wireless multimedia connection standard such as WiDi, and a WiDi application 118 operating on the receiving computing device 114 and the television 116. Ultimately, the transmitted multimedia content (e.g., streaming video) may be displayed at the final receiving device, e.g., television 116.

WiDi may not only be used to provide communicate multimedia content with output devices such as televisions, but may also be used to communicate multimedia content with input devices such as video cameras. Another example use case of WiDi includes a video conferencing application over cellular-enabled client devices (e.g., user equipment (UE)) corresponding to conversational and streaming video services. A video conferencing application (e.g., Skype) over an IP multimedia subsystem (IMS)—may be integrated to have the UE use the wireless webcam feature of WiDi. Consequently, video may also be signaled over a WiFi P2P connection from the UE to the WiDi adapter (in addition to the cellular network).

Although the presently disclosed techniques and configurations provide a number of examples related to WiDi, WirelessHD, and similar wireless multimedia networking configurations, this disclosure is applicable to a larger number of heterogeneous UE connectivity scenarios. Moreover, a wireless multimedia delivery network is not limited to use of a cellular network, but may involve a variety of other wireless standards and configurations, including but not limited to a Wireless Wide Area Network (WWAN), a WLAN, or a WPAN network, an unmanaged WiFi network, or a TV broadcast network (e.g., DVB).

In example embodiments, a series of adaptive streaming services are provided to enable QoE via wireless multimedia networking configurations. The adaptive streaming services enhancing QoE via cross-layer optimization may include one or more of:
An end-to-end QoS architecture for adaptive multimedia streaming in which the target QoS parameters for the core network and/or radio access network may be derived from multimedia-specific and application-layer parameters, determined from values such as provided from the session description protocol (SDP) for RTSP-based adaptive streaming or media presentation description (MPD) metadata for HTTP-based adaptive streaming, as well as from receiver device/display capabilities and physical link conditions;
A Carrier sense multiple access with collision avoidance (CSMA/CA)-based multimedia QoS and traffic prioritization framework in which access categories and associated system parameters (e.g., Arbitration Inter-Frame Space Number (AIFSN), Connection Window (CW) and Transmit Opportunity (TXOP) parameters) for HCF Controlled Channel Access (HCCA) or Enhanced Distributed Channel Access (EDCA) may be determined based on QoE-optimized mapping functions derived from the multimedia-specific application-layer parameters in the SDP or MPD for RTSP/HTTP-based adaptive streaming services, receiver device/display capabilities, and physical link conditions;
Client device configurations to manage the streaming session, modify session parameters (e.g., derive new RTSP/SDP session parameters), adapt video parameters (e.g., bitrate, resolution, frame rate, etc.), prioritize traffic, allocate resources and optimize bandwidth/QoS for its local connections (e.g., WiDi links) based on multimedia information gathered from session-level signaling (e.g., SDP or MPD signaling) over the other video delivery networks (e.g., 3GPP, Wi-Fi, or digital video broadcasting networks) using Session Initiation Protocol (SIP), RTSP, or HTTP protocols, including codec information, quality requirements, and rate-distortion characteristics;
A client signaling mechanism to exchange multimedia-specific application-layer parameters with the SDP or MPD values (or any other metadata carrying multimedia-specific parameters), and/or receiver device/display capabilities in a radio access network towards enabling coordinated QoE optimization, application-aware network adaptation, and QoS support and resource management for adaptive streaming services; and
A QoE-aware cross-layer cooperation framework for the adaptive streaming client platform architecture in order to jointly optimize platform parameters for RTSP or HTTP-based streaming, video/network/radio adaptation, and QoS support.

In this context, the present disclosure provides techniques to optimize channel access among concurrent wireless multimedia network applications for delivering the best possible QoE of multimedia content. This may provide enhanced operations applicable to: 1) Multiple concurrent multimedia network adaptive streaming applications (e.g., via a WiDi connection) carrying different multimedia content or displayed on different screens; 2) Wireless webcam and video conferencing over a multimedia wireless network; and 3) Internet video streaming over a multimedia wireless network, such as with use of adaptive HTTP streaming services, to one or more displays.

In order to effectively perform adaptive streaming in a multi-access environment, it is important to ensure that the wireless multimedia network links share the medium in a “content-aware” fashion with appropriate video adaptation and QoS prioritizations among the streams during channel access. The presently described techniques and system configurations enable content-aware selection video adaptation parameters and WiFi-based Dynamic Channel Allocation (DCA) QoS parameters for different WiDi connections in order to share resources efficiently and realize the best possible video quality levels over all active wireless multimedia network applications.

Applicability to State-Tracking, Stateless, and Adaptive Streaming Services

The following streaming protocols may be used in conjunction with the presently disclosed cross-layer optimization techniques. These streaming protocols include:

State-Tracking Protocols. Traditional streaming services (e.g., conducted with the RTSP) generally use a state-tracking protocol, where once a client connects to the streaming server, the server keeps track of the client's state until the client disconnects again. Typically, frequent communication between the client and the server occurs for purposes such as session provisioning and negotiation of media parameters. Once a session between the client and the server has been established, the server sends the media as a continuous stream of packets over either UDP or TCP transport. The application-layer information on the multimedia-specific parameters is typically communicated by SDP. Example technologies using RTSP-based streaming include Microsoft Windows Media, Apple QuickTime, Adobe Flash, and Real Networks Helix. Some implementations of WiDi also use RTSP-based streaming.

Stateless Protocols. Another option for adaptive streaming is via a stateless protocol, such as the HTTP protocol. With use of the HTTP protocol, as a client requests data, the server responds by sending the data and then the transaction is terminated. Each HTTP request is handled as a completely standalone one-time transaction. HTTP-based progressive download methods may also be used for media delivery from standard Web servers. In HTTP-based progressive download, supported clients can seek positions in a media file by performing byte range requests to the Web server. Some of the disadvantages of HTTP-based progressive download include that (i) bandwidth may be wasted if the user decides to stop watching the content after progressive download has started (e.g., switching to another content), (ii) the download is not bitrate adaptive, and (iii) the download does not support live media services.

Adaptive Streaming. Dynamic adaptive streaming over HTTP (DASH) addresses some of the weaknesses of Real-time Transport Protocol (RTP)/RTSP-based streaming and HTTP-based progressive downloads. DASH provides the ability to move control of a “streaming session” entirely to the client and therefore moves the adaptive streaming intelligence from the server to the client. The client may open one or several or many TCP connections to one or several standard HTTP servers or caches, retrieve the MPD metadata file providing information on the structure and different versions of the media content stored in the server (including different bitrates, frame rates, resolutions, codec types, etc.) and request smaller segments of the selected version of the media file with individual HTTP messages (to imitate streaming via short downloads).

DASH provides the ability to the client to automatically choose an initial content rate to match initial available bandwidth without requiring a negotiation with the streaming server. DASH further provides the ability to dynamically switch between different bitrate representations of the media content as the available bandwidth changes. Hence, DASH allows faster adaptation to changing network and wireless link conditions, user preferences, and device capabilities (e.g., display resolution, CPU, memory resources, etc.). Such dynamic adaptation may enable an improved user quality of experience (QoE), with shorter startup delays, fewer re-buffering events, and the like. Example DASH technologies include Microsoft Internet Information Services (IIS) Smooth Streaming, Apple HTTP Live Streaming, and Adobe HTTP Dynamic Streaming.

End-to-End QoS Architecture for Adaptive Streaming

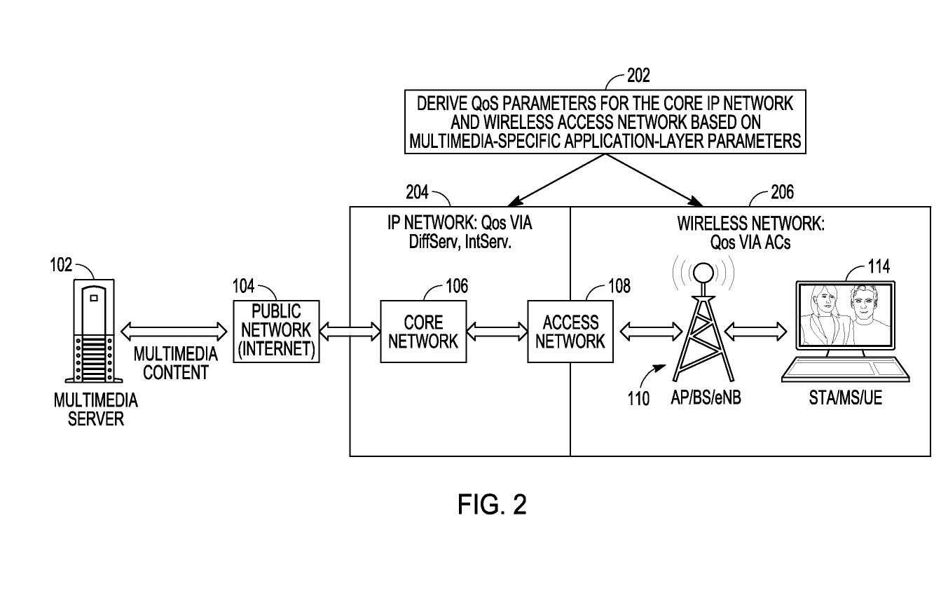

Providing a sufficiently detailed end-to-end QoS implementation that optimizes adaptive streaming requires the consideration of the interfaces provided by the wireless network, access network, and core network used to transfer data. FIG. 2 provides an illustration of a QoS-aware network architecture, configured to access multimedia content provided by a multimedia server 102 from a public network 104 (e.g., the internet) via each of these network interfaces.

Communications provided for the multimedia content within the non-wireless IP network 204 (e.g., a LTE IP network) include transfer of data from the public network 104 via the core network 106, and the transfer of data from the core network 106 via the access network 108. Communications provided for the multimedia content within the wireless network 206 (e.g., a LTE wireless network) include the transfer of data from the access network 108 to the access point/base station/eNodeB 110, and the transfer of data from the access point/base station/eNodeB 110 wirelessly to the receiving computing device 114 (a mobile station/user equipment).

As illustrated, QoS parameters 202 for the non-wireless IP network 204 and the wireless network 206 may be derived based on multimedia-specific application-layer parameters. These derived QoS parameters 202 may then be provided to the various components and interfaces within the non-wireless IP network 204 and the wireless network 206, including the core network 106, the access network 108, and the wireless network interface operated by the access point/base station/eNodeB 110.

Regarding the specific wireless network interface (e.g., IEEE standard 802.11e, WiFi Multimedia (WMM), etc.) used in the wireless network 206, each interface defines a set of QoS classes or access categories (ACs) (e.g., best effort (AC_BE), background (AC_BK), voice (AC_VO), and video (AC_VI) access categories for the WiFi Multimedia (WMM) standard as part of enhanced distributed coordination function (DCF) channel access (EDCA)) and specifies associated service attributes in terms of various performance requirements such as throughput, latency/jitter, packet error-loss rate, and the like (e.g., via TSPECs, etc.). The QoS classes/ACs enable the differentiation of the service flows between client applications and various services. In one example embodiment, each service flow is mapped to a specific QoS class and receives a common QoS treatment. This allows service flows to be prioritized accordingly, when resources are distributed between different service flows through scheduling functions.

Some examples for QoS definitions that may be used in IP network 204, specifically in core network 106 and access network 108, are Differentiated Services—DiffSery (RFC 2474) and Integrated Services—IntSery (RFC 1633), specified by the Internet Engineering Task Force (IETF). IntSery follows the flow-based and signaled QoS model, where the end-hosts signal QoS needs to the network, while DiffSery works on the provisioned-QoS model, where network elements are set up to service multiple classes of traffic with varying QoS requirements. In particular, DiffSery uses the 6-bit Differentiated Services Code Point (DSCP) field in the header of IP packets for packet classification purposes. The IntSery model relies on the Resource Reservation Protocol (RSVP) to explicitly signal and reserve the desired QoS for each flow in the network, described by the FlowSpecs. In order to provide multi-layer QoS control and manage end-to-end QoS, a convergence sub-layer is defined to interface higher-layer protocol data units and perform classification and mapping functions. For example, in the case of DiffServ, each end-to-end IP packet entering the system is identified with a dedicated air interface AC for the radio access network, by mapping its DSCP over the core network from DiffSery to a particular QoS class for the radio access network.

The configuration illustrated in FIG. 2 therefore enables an end-to-end QoS architecture for adaptive streaming in which target QoS parameters for the core network and/or radio access network (including local P2P connections) are derived. These values may be derived based on multimedia-specific application-layer parameters, such as from SDP values for RTSP-based adaptive streaming or MPD values for HTTP-based adaptive streaming, as well as based on the receiver device/display capabilities and physical link conditions.

In this context, the IP and wireless network devices (STAs, APs, etc., including client devices) may be configured to (i) have the ability to parse the SDP or MPD values in order to extract multimedia-specific application layer information for a given streaming session, (ii) exchange information on the receiver device/display capabilities and/or physical link conditions, and (iii) derive target video adaptation parameters and QoS parameters for the core network and radio access network.

As a potential implementation of deriving QoS parameters in one example embodiment, IP and wireless network devices may be configured to perform mapping from the multimedia-specific application-layer information contained in the SDP or MPD values (or from any similar metadata format carrying multimedia information), or receiver device/display capabilities, or physical link conditions to:
1) The set of video adaptation parameters (e.g., bitrate, resolution, frame rate, etc.) and QoS parameters for the core network, e.g., DiffServ/DSCP parameters, IntServ/FlowSpecs parameters, etc.
2) The set of video adaptation parameters (e.g., bitrate, resolution, frame rate, etc.) and QoS parameters for the radio access network, e.g., QoS class or access category (AC) parameters, TSPECs, etc.
3) The set of video adaptation parameters (e.g., bitrate, resolution, frame rate, etc.) and QoS parameters for the local P2P network among client devices (e.g., a WiFi P2P network as in the WiDi use case), including QoS class or access category (AC) parameters, TSPECs, and the like.

Furthermore, the network devices (including radio access network devices and client devices, e.g., STAs) may signal the SDP or MPD values (or any such metadata carrying multimedia information) as well as the receiver device/display capabilities to other network devices in order to share adaptive streaming related session information with the appropriate entities in the network. In such cases, the decisions on the video adaptation parameters and QoS parameters (QoS class or access category (AC) parameters, etc.) for all clients sharing the resources/spectrum can be made jointly in order to find the QoE-optimizing traffic prioritization among the clients in a coordinated fashion.

Apart from QoS enhancements, the exchange of multimedia-specific application layer information contained in the SDP or MPD attributes among network devices would be beneficial for other use cases as well, such as QoE-optimal adaptive streaming during session transfer among client devices.

The set of multimedia-specific application-layer parameters provided by the SDP, MPD, or any other similar metadata format can include one or more of the following multimedia parameters:
Type of multimedia application, e.g., video conferencing, real-time video streaming, video downloading/uploading, stored or internet-streamed video, DVD or Blue-Ray video playback, etc.
Type of multimedia, e.g., image, video, audio, voice, etc.
Application-level constraints for the multimedia content, e.g., delay, jitter, reliability, quality requirements, etc., and recommended QoS class and parameter information.
Multimedia bitrate, resolution, and frame rate information, including a maximum bitrate above which the perceived quality improvement is negligible, and a minimum bitrate to achieve the lowest acceptable quality.
Multimedia codec information, e.g., codec type such as AMR, MPEG4, H.264 AVC/SVC etc., possibly also describing profiles and levels.
Multimedia quality metrics specified at different bitrates, frame rates and resolutions, such as reference, reduced-reference or non-reference metrics, e.g., video quality metrics (VQM), structural similarity metrics (SSIM), perceptual evaluation of video quality metrics (PEVQ), video mean opinion scores (MOS), and other subjective quality metrics.
Device capability information and display properties, including screen size, resolution, and bit depth.
Encoding information, such as the number of group of pictures (GOP) frames, GOP size, and frame type (e.g., I-frame, P-frame, B-frame, etc.).
Quantization parameters for different frames, e.g., varying quantization scales for I-, P-, B-frames, etc.
Layer type for scalable video coding (SVC), e.g., base layer, enhancement layer, etc.
Application-level Forward Error Correction (FEC), erasure coding, or network coding parameters.
Session and RTCP signaling bandwidth information (e.g., bandwidth modifiers used with SDP).
Pre-decoder buffer size, initial buffering period, decoder capability information.
Streaming method (RTSP, HTTP, etc.).
Support for QoE, Adaptation, Extended RTCP reporting, fast content switching, and RTP profiles.

CSMA/CA-Based Multimedia QoS and Traffic Prioritization Framework

Standards disclosed in IEEE standard 802.11e provide a QoS extension of the distributed coordination function (DCF) and the point coordination function (PCF) of 802.11 wireless networking standards, through a new coordination function: the hybrid coordination function (HCF). Within the HCF, there are two methods of channel access, similar to those defined in the legacy 802.11 MAC: HCF Controlled Channel Access (HCCA) and Enhanced Distributed Channel Access (EDCA). Both EDCA and HCCA define Traffic Categories (TC). While the forthcoming discussion will address EDCA only, it should be understood that the scope of the techniques proposed here are also applicable to HCCA-based QoS delivery as HCCA also relies on the same TCs for traffic prioritization.

In one embodiment, an enhancement to support QoS enables EDCA to differentiate packets using different priorities and maps them to specific ACs that are buffered in separate queues at a station. Each AC i within a station having its own EDCA parameters contends for the channel access independently of the others. Levels of services may be provided through different assignments of the AC-specific EDCA parameters: AIFS, CW, and TXOP limits (AIFS=arbitration inter-frame space, CW=contention window, TXOP=transmit opportunity), allowing for prioritization of channel access among different ACs. The channel access probability differentiation is provided by using: a) different AIFSs instead of the constant distributed IFS (DIFS) used in DCF, and, b) different values for the minimum/maximum CWs to be used for the backoff time extraction.

AIFSN Prioritization: If there is a packet ready for transmission in the MAC queue of an AC, the EDCA function will sense the channel to be idle for a complete AIFS before it can start the transmission or backoff countdown. The AIFS of AC i may be determined as follows:

AIFS_{—}i=SIFS+AIFSN_{—}i*T_slot

where AIFSN_i is the AC-specific AIFS number corresponding to AC i, SIFS is the length of the short inter-frame space and T_slot is the duration of a time slot.

CW Prioritization: If the channel is idle when the first packet arrives at the AC i queue, the packet can be directly transmitted as soon as the channel is sensed to be idle for AIFS_i. Otherwise, a backoff procedure is completed following the completion of AIFS before the transmission of this packet. A uniformly distributed random integer, namely a backoff value, is selected from the range [0, W_i]. The backoff counter is decremented at the slot boundary if the previous time slot is idle. Should the channel be sensed busy at any time slot during AIFS or backoff, the backoff procedure is suspended at the current backoff value. The backoff resumes as soon as the channel is sensed to be idle for AIFS again. When the backoff counter reaches zero, the packet is transmitted in the following slot. The value of W_i depends on the number of retransmissions the current packet experienced. The initial value of W_i is set to CWmin_i. If the transmitter cannot receive an Acknowledgment (ACK) packet from the receiver in a timeout interval, the transmission is labeled as unsuccessful and the packet is scheduled for retransmission. At each unsuccessful transmission, the value of W_i is doubled until CWmax_i is reached. The value of W_i is reset to CWmin_i if the transmission is successful; or the packet retransmission limit is reached the packet is dropped.

The ACs with higher priority are assigned a smaller AIFSN value. Therefore, the ACs with higher priority can either transmit or decrement their backoff counters while ACs with lower priority are still waiting in AIFS. This results in ACs with higher priority enjoying a relatively faster progress through backoff slots. Moreover, the ACs with higher priority may select backoff values from a comparably smaller CW range. This approach prioritizes the access because a smaller CW value means a smaller backoff delay before the transmission.

TXOP Prioritization: TXOP is a bounded time interval during which a station can send as many frames as possible as long as the duration of the transmissions does not extend beyond the maximum duration of the TXOP. Upon gaining access to the medium, each AC i may carry out multiple frame exchange sequences as long as the total access duration does not go over MaxTXOP_i. In a TXOP, the transmissions are separated by SIFS. Multiple frame transmissions in a TXOP can reduce the overhead due to contention. A TXOP limit of zero corresponds to only one frame exchange per access. The ACs with higher priority may use a nonzero TXOP to increase their channel access time, with TXOP durations ranked according to the AC priority (i.e., the highest priority AC may have the largest TXOP).

In one embodiment, the previously described CSMA/CA-based multimedia QoS and traffic prioritization framework determines the access categories and associated system parameters (e.g., AIFSN, CW, and TXOP parameters) for EDCA or HCCA values. These values may be implemented based on QoE-optimized mapping functions derived from the multimedia-specific application-layer parameters in the SDP or MPD values (or any other similar metadata format), receiver device/display capabilities, or physical link conditions for RTSP/HTTP-based adaptive streaming services.

Furthermore, the network devices (including radio access network devices and client devices, e.g., STAs) may signal the SDP or MPD information as well as the receiver device/display capabilities to other network devices in order to share adaptive streaming related session information with the appropriate entities in the network. In such cases, the decisions on the QoS parameters (QoS class or access category (AC) parameters, etc.) for all clients sharing the resources/spectrum can be made jointly in order to find the QoE-optimizing traffic prioritization among the clients in a coordinated fashion.

QoE-Optimizing Platform Adaptation Architecture for Adaptive Streaming

In another example embodiment, a cross-layer optimized platform adaptation architecture is defined for adaptive streaming, in which video, transport and radio components in the platform cooperate and exchange information towards identifying platform configurations needed to optimize user QoE.

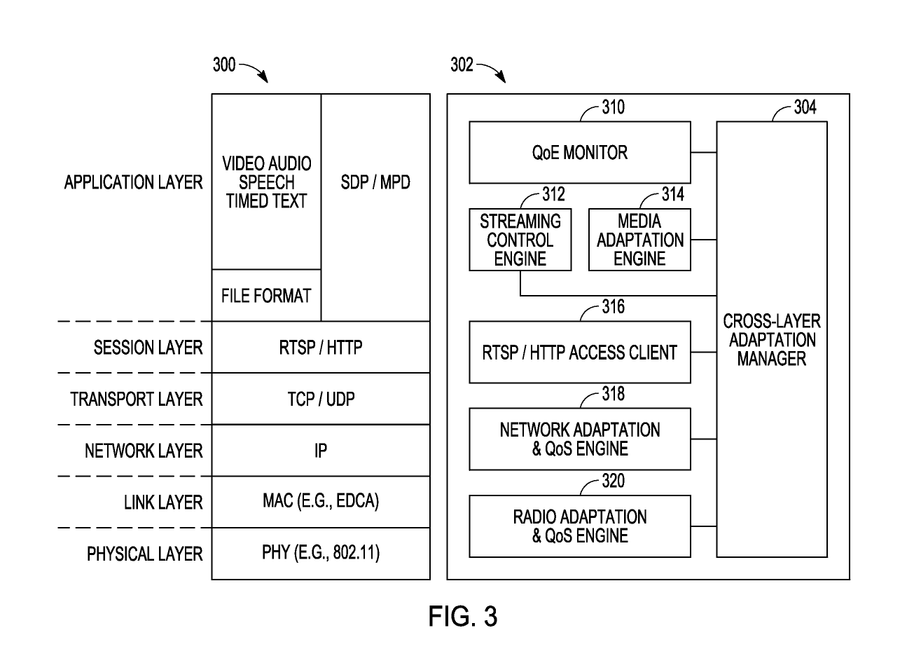

An example client adaptation architecture 302 illustrated against a series of associated Open Systems Interconnection (OSI) communication layers and protocols 300 is depicted in FIG. 3. As illustrated, a cross-layer adaptation manager 304 extending across each of the OSI communication layers is operable with each of the following system components:

Radio Adaptation and QoS engine 320: Determines radio-level adaptation and QoS parameters;

Network Adaptation and QoS engine 318: Determines network-level adaptation and QoS parameters;

RTSP/HTTP Access Client 316: Handles transport-level RTSP/RTP/UDP/IP or HTTP/TCP/IP operations, and establishes and manages the RTSP/HTTP transport connections;

Adaptive Streaming Control Engine 312: Parses the SDP or MPD parameters and determines streaming parameters for adaptive streaming (e.g., DASH segment duration, sequence and timing of HTTP requests, etc.);

Media Adaptation Engine 314: Determines codec-level adaptation parameters; and

QoE monitor 310: Dynamically measures QoE.

For example, DASH client platform configurations may be jointly optimized at the video, transport and radio levels via cross-layer cooperation of the cross-layer adaptation manager 304, and associated system components, in connection with the following parameters at each appropriate layer:
Application (Video) layer: Bitrate, frame rate, resolution, the decisions of the client to drive the requested content representations from the DASH server;
Transport layer: QoE feedback based on the real-time transport control protocol (RTCP), sequence and timing of HTTP requests, number of parallel TCP connections, DASH segment durations, and so forth;
Network, and Link and Physical (Radio) layers: Modulation and coding scheme (MCS), target QoS parameters for the core network and radio access network.

Further, in one embodiment, the adaptive streaming client platform can dynamically track the following parameters, and use parameter values as inputs for decisions towards jointly adapting the streaming client configurations via cross-layer cooperation:
Measured QoE parameters, e.g., video quality metrics (VQM), structural similarity metrics (SSIM), perceptual evaluation of video quality metrics (PEVQ), video mean opinion scores (MOS), etc and other subjective quality metrics;
Measured video rate-distortion characteristics;
User preferences at the application layer;
Multimedia-related information retrieved from SDP or MPD parameters;
Information received from the network on current QoS availability and network congestion states;
Measured dynamic QoS parameters (e.g., throughput, latency, reliability, etc.);
Measured dynamic channel/network conditions at the radio and transport levels; and
Power/latency budgets and CPU/buffer/memory requirements at the platform architecture level.

Wireless Multimedia Network Applications

As previously described, the present network enhancement techniques are applicable to Wireless Multimedia Network protocols such as WiDi, which may implement a special case of the proposed end-to-end QoS architecture. Due to its simple point-to-point communication setting, WiDi allows for full control over both transmit and receive ends of the link, allowing for highly-optimized multimedia adaptation.

Adaptive streaming over WiDi may be performed using the RTSP protocol. In this context, a cross-layer coordinated QoS framework may be adapted to optimize channel access among concurrent WiDi applications for delivering the best possible multimedia QoE, allowing effective performance of adaptive streaming with QoE in a multi-access environment. This may help ensure that the WiDi links share the medium in a “content-aware” and “display aware” fashion with the appropriate prioritizations among the streams during channel access.

More specifically, this embodiment may enable content-aware and display-aware selection video adaptation (bitrate, resolution, frame rate, content characteristics, etc.), DCA, and target QoS parameters for different WiDi connections in order to share resources efficiently and realize the best possible video quality levels over all WiDi applications. In addition, this embodiment may also factor the type of content being broadcasted. For example, a low-definition action movie or sports presentation may require more data transmission and throughput than a higher-definition low-motion movie.

In one embodiment, the presented CSMA/CA-based multimedia QoS and traffic prioritization framework is applicable such that access categories and associated system parameters (e.g., AIFSN, CW and TXOP parameters) for EDCA or HCCA are determined based on QoE-optimized mapping functions derived from the multimedia-specific application-layer parameters in the SDP, receiver device/display capabilities and physical link conditions, and the like.

For example, WiDi devices may utilize RTSP/SDP-based signaling mechanisms to exchange multimedia-specific application-layer parameters and receiver device/display capability information over the radio links. These parameters and capability information may be applied to enable coordinated QoE optimization, application-aware network adaptation, QoS support, and resource management for adaptive streaming services transmitting over a WiDi connection. Therefore, a client device running a WiDi application may manage the streaming session, modify session parameters (e.g., derive new RTSP/SDP session parameters), adapt video parameters (e.g., bitrate, resolution, frame rate, etc.), prioritize traffic, allocate resources and optimize bandwidth/QoS for its local connections (e.g., WiDi links) to the displays based on multimedia information gathered from session-level signaling (e.g., SDP or MPD signaling) over the other video delivery networks (e.g., 3GPP, WiFi or DVB networks) using SIP, RTSP or HTTP protocols, including codec information, quality requirements, and rate-distortion characteristics.

A WiDi client platform architecture may also perform RTSP-based adaptive streaming based on the proposed QoE-aware cross-layer cooperation framework in order to jointly optimize platform parameters for video/network/radio adaptation and QoS support. For example, WiDi devices may signal the RTSP/SDP or MPD information as well as the receiver device/display capabilities to other WiDi devices in order to share adaptive streaming related session information with the appropriate entities in the network. In such cases, the decisions on the QoS parameters (QoS class or access category (AC) parameters, etc.) for all clients sharing the resources/spectrum can be made jointly in order to find the QoE-optimizing traffic prioritization among the clients in a coordinated fashion.

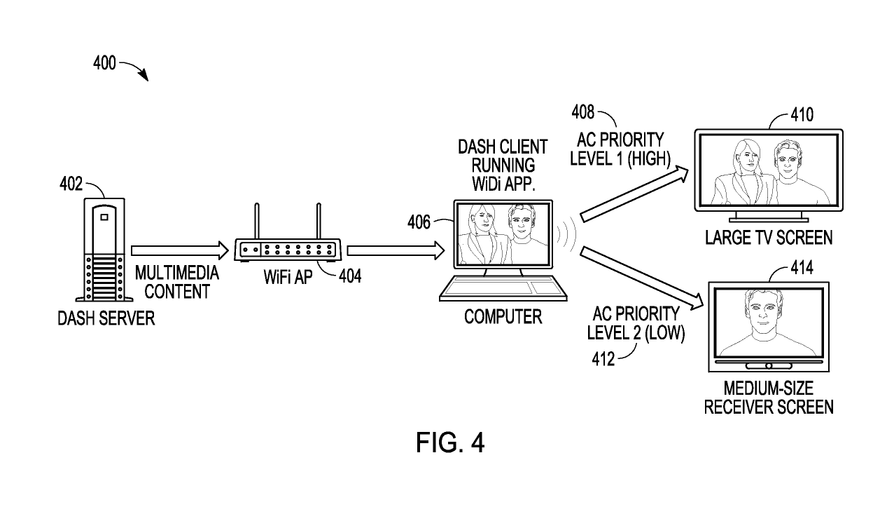

FIG. 4 provides an illustration of an example network configuration 400 for transmitting streaming multimedia content with a DASH adaptive streaming protocol in accordance with an example embodiment. FIG. 4 specifically depicts an example use case of over-the-top Internet video streaming using DASH and adaptive HTTP techniques, e.g., Apple HTTP Live Streaming. As illustrated, multimedia content is communicated from a DASH server 402 to a WiFi AP 404, and then via a WiFi network to a computer 406 running a DASH Client and a WiDi communications application. The computer 406 utilizes the WiDi communications application to transmit multimedia content via a WiDi WiFi P2P network to two devices, a large-sized screen television 410 and a medium-sized receiver screen 414 (e.g., a computing device or another display device with a smaller screen than television 410).

In this particular scenario, two different video streams are to be received by the DASH client from one or more DASH servers to be projected onto two different displays with varying characteristics. Accordingly, the DASH Client first fetches the MPD from the DASH server(s) and learns about multimedia characteristics for content to be streamed over the WiDi links (e.g., these parameters may include minimum bitrate for acceptable video quality and maximum bitrate above which perceived video quality improvement is negligible). This is followed by the DASH client using RTSP/SDP signaling to gather capability information from each of the displays. The DASH client then estimates link qualities to each of the displays based on the physical channel conditions (e.g. by tracking packet error/loss statistics).

The network configuration 400 is specifically configured to provide the multimedia content to the large screen television 410 at a high priority 408 (e.g., AC Priority Level 1). The network configuration 400 is further configured to provide the multimedia content to the medium-sized receiver screen 414 at a low priority 412 (e.g., AC Priority Level 2).

Based on the MPD information, display capabilities, and physical link conditions gathered from the first three steps, the DASH client may next determine the QoE-optimizing adaptive streaming configuration including video adaptation parameters and QoS parameters. Finally, the DASH client streams content to the displays based on the QoE-optimizing content-aware and display-aware adaptive streaming configuration based on the selected video adaptation parameters and QoS parameters.

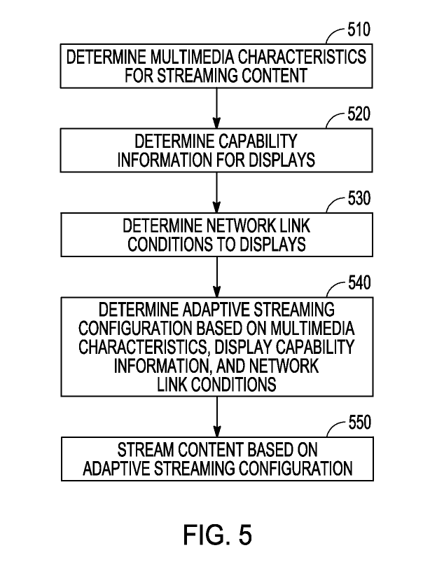

FIG. 5 provides an illustration of a method for QoE-optimization procedure for DASH-based video streaming according to one embodiment. First, multimedia characteristics for the streaming content may be determined (operation 510), for example, by the DASH client obtaining the MPD from the DASH server(s) and analyzing multimedia characteristics for content to be streamed over the WiDi links. Capability information for the various displays may be determined (operation 520), for example, by the DASH client using RTSP/SDP signaling to gather capability information from each of the displays. Network link conditions to the displays or display clients may be determined (operation 530), for example, by the DASH client estimating link qualities to each of the displays based on the physical channel conditions (such as by tracking packet error/loss statistics).

Based on the previously determined multimedia characteristics, display capability information, and network link conditions, an adaptive streaming configuration may be determined (operation 540). For example, the DASH client may calculate relevant QoE-optimizing adaptive streaming configuration parameters including video adaptation parameters and QoS parameters using the previously described MPD information, display capabilities, and physical link conditions.

Finally, content may be streamed based on the determined adaptive streaming configuration (operation 550). For example, the DASH client may stream content to the displays based on the QoE-optimizing adaptive streaming configuration parameters including the previously described video adaptation parameters and QoS parameters.

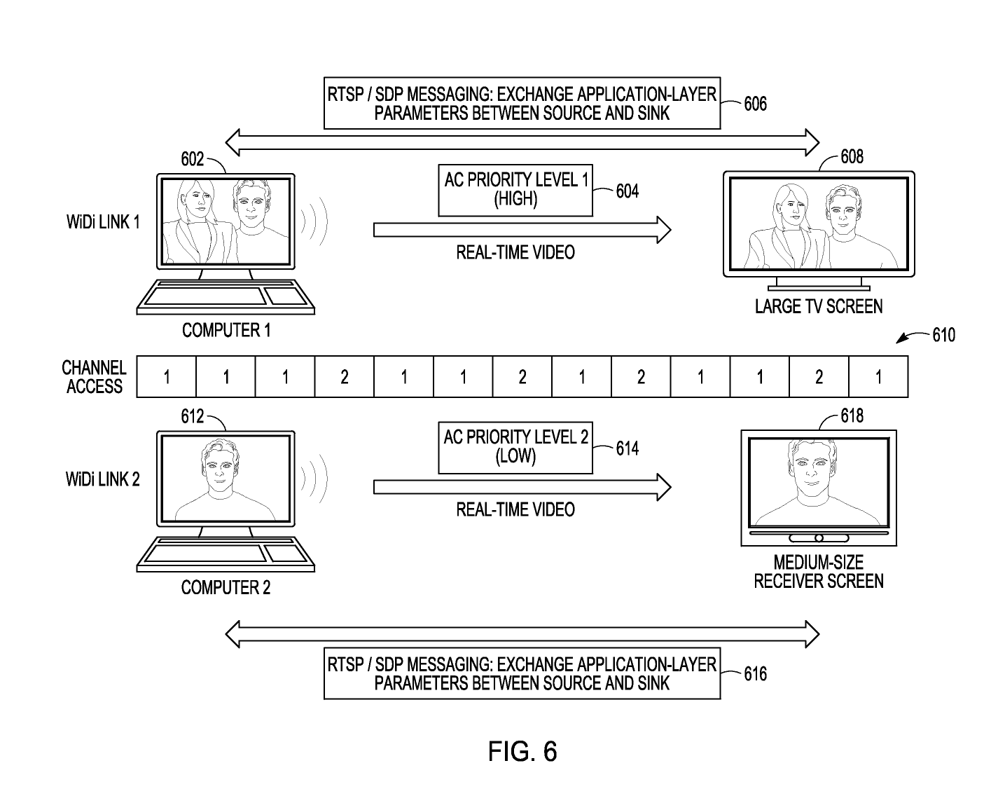

FIG. 6 illustrates another example embodiment of cross-layer optimized adaptive streaming techniques, with a network architecture supporting a two-user WiFi network where each user is concurrently running WiDi applications to stream multimedia content. As depicted, WiDi Link 1 is configured to transmit real-time video from computing system 602 to large screen television 608 with a high priority level 604. Within WiDi Link 1, RTSP/SDP messaging 606 is configured to exchange application-layer parameters between the source (computing system 602) and sink (television 608). As further depicted, WiDi Link 2 is also configured to transmit real-time video from computing system 612 to medium-sized screen receiver device 618 with a low priority level 614; and likewise, WiDi Link 2 exchanges similar RTSP/SDP messaging 616 between the computing system 612 and the receiver device 618.

Using the RTSP/SDP-based signaling 606, 614 between each of the source-sink device pairs, each WiDi configuration determines the application layer parameters associated with display capabilities, parses the locally stored SDP for each video content to gather multimedia-specific information, estimates the physical link conditions, and uses these criteria to determine the QoE optimizing video adaptation parameters/QoS access category/and associated EDCA/HCCA parameters corresponding to their multimedia streams.

For example, suppose user of WiDi Link 1 would like to stream a fast-moving high quality video stream to a large screen TV 608 with a minimum bitrate equivalent to 4 Mbps of channel capacity in order to meet the target QoE for the video stream, while the user of WiDi Link 2 would like to stream a slow moving lower quality video stream to a medium-sized screen receiver device 618 with a minimum bitrate equivalent to 2 Mbps of channel capacity in order to meet the target QoE for the video stream. Hence, WiDi Link 1 has a more stringent QoE and bitrate requirement compared to WiDi Link 2. Consequently, WiDi Link 1 is assigned to a higher priority level 604 while WiDi Link 2 is assigned to a lower priority level 614, allowing WiDi Link 1 to utilize more of the channel capacity resources and thereby meet its higher bitrate requirement. Through such content-aware channel access, both users are able to meet their QoE requirements and enjoy a satisfying video streaming experience.

Suppose in the illustrated example of FIG. 6 that the channel capacity provided to both users is approximately 6 Mbps. Therefore, in a legacy DCF framework in which both users would have equal priority for channel access, each WiDi link could only realize an average throughput of 3 Mbps. While this throughput would allow WiDi Link 2 to meet its target QoE requirement, WiDi Link 1 would not be able to meet its target QoE requirement.

As a remedy, a content-aware channel access solution in accordance with one embodiment considers provides a CWmin ratio of 2:1 in the QoS prioritized CSMA/CA-based WiFi access. This is illustrated in the channel access 610 for the WiFi network used to transmit the data via the WiDi links, configured to allow up to two times higher throughput for WiDi Link 1 in comparison with WiDi Link 2 (i.e., WiDi Link 1 gains access to ⅔ of the channel bandwidth, while WiDi Link 2 gains access to ⅓ of the channel bandwidth). This results in WiDi Link 1 realizing 4 Mbps of WiDi throughput and WiDi Link 2 realizing 2 Mbps of WiDi throughput. Hence, both users are able to meet their target QoE requirements.

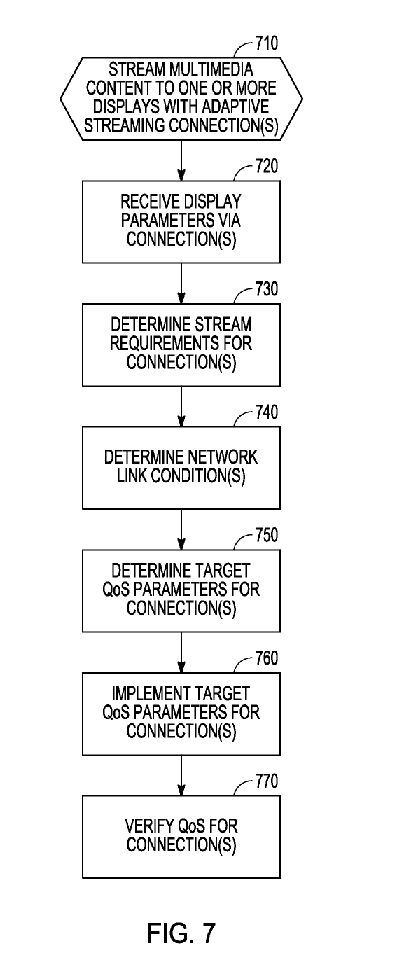

FIG. 7 provides a summarized illustration of a method used to implement adaptive streaming optimization, with use of various of the previously described techniques according to one example embodiment. As illustrated, the adaptive streaming optimization occurs in connection with streaming multimedia content to one or more displays with one or more adaptive streaming connections (operation 710).

The calculations performed with the adaptive streaming optimization may include: receiving display parameters via the connection(s) (operation 720); determining the stream requirements for the connection(s) (operation 730); determining the network link condition(s) for the connection(s) (operation 740); and determining the target QoS parameters for the connection(s) (operation 750). The target QoS parameters are then implemented for the connection(s) (operation 760). The result of the implemented QoS parameters for the connection(s) may then be verified (operation 770), with further adjustments and implementations to the QoS parameters provided in subsequent activities.

Although the previously described techniques and configurations were provided with reference to specific implementations of wireless multimedia networks such as WiDi, these techniques and configurations may also be applicable to a variety of WLANs, WWANs, and wireless communication standards implementing communication quality-enhancing techniques. Further, the previously described techniques and configurations may be applied within any number of multimedia streaming applications and protocols over wireless networks to enhance user quality of experience through the proposed cross-layer optimized and QoS-enabled adaptive streaming techniques.

Embodiments may be implemented in one or a combination of hardware, firmware, and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, communication devices such as a base station or UE may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method performed by a transmitting device for adaptive streaming optimization within a wireless local area network, comprising:
determining target quality of service (QoS) parameters for an adaptive streaming communication within the wireless local area network from multimedia-specific parameters, receiver display capabilities of one or more receiving devices, and link conditions; and
transmitting the adaptive streaming communication in the wireless local area network in accordance with the target QoS parameters;
wherein the target QoS parameters are implemented using cross-layer adaptation among a plurality of network levels in the wireless local area network to provide quality of experience (QoE) for multimedia content to be delivered by the adaptive streaming communication.

2. The method of claim 1, wherein the wireless local area network operates using a carrier sense multiple access/collision avoidance (CSMA/CA) protocol, and wherein implementing the target QoS parameters within the network includes providing QoS and traffic prioritization in connection with CSMA/CA-based operations of the wireless local area network.

3. The method of claim 2, wherein access categories and associated system parameters for Enhanced Distributed Channel Access (EDCA) or Hybrid Coordination Function Controlled Channel Access (HCCA) used in the wireless local area network are determined based on the multimedia-specific parameters, the receiver display capabilities, and the link conditions.

4. The method of claim 1, wherein the wireless local area network is operably coupled to a core network providing the multimedia content, the method further comprising implementing the target QoS parameters within the core network.

5. The method of claim 1, wherein the adaptive streaming communication over the wireless local area network is conducted using Real Time Streaming Protocol (RTSP) streaming, and wherein the multimedia-specific parameters are communicated to the transmitting device within session description protocol (SDP) parameters.

6. The method of claim 1, wherein the adaptive streaming communication over the wireless local area network is conducted using Real Time Streaming Protocol (RTSP) streaming, and wherein the multimedia-specific parameters are communicated to the transmitting device in media presentation description (MPD) metadata used for Hypertext Transport Protocol (HTTP)-based adaptive streaming.

7. The method of claim 1, further comprising:
receiving client signaling in connection with the adaptive streaming communication, the client signaling indicating at least one of the multimedia-specific parameters, the receiver display capabilities, and the link conditions.

8. The method of claim 1, further comprising:
adapting the target QoS parameters, bandwidth allocations, transport parameters, and multimedia streaming parameters at application, session, and transport layers of the wireless local area network based on the multimedia-specific parameters, the receiver display capabilities, and the link conditions, to further provide the QoE for the multimedia content delivered by the adaptive streaming communication.

9. The method of claim 1, further comprising:
adapting parameters of the multimedia content to provide the QoE for the multimedia content delivered by the adaptive streaming communication, including modifying at least one of bitrate, resolution, or frame rate of the multimedia content.

10. The method of claim 1, wherein determining the target QoS parameters includes factoring multimedia-specific parameters, receiver display capabilities, and link conditions from at least one additional adaptive streaming communication occurring over the network.

11. The method of claim 10, wherein the adaptive streaming communication is transmitted to a first receiving device, and wherein the at least one additional adaptive streaming communication is transmitted to at least one additional receiving device.

12. The method of claim 1, wherein the adaptive streaming communication is provided as a digital transmission of video and audio data signals to a receiving device using a peer-to-peer (P2P) connection over the wireless local access network.

13. A network communications device, comprising:
processing-layer circuitry configured to provide a cross-layer adaptation manager for optimizing adaptive streaming at multiple network layers in connection with wireless network communications performed by the network communications device, the cross-layer adaptation manager configured to:
calculate target quality of service (QoS) parameters for the wireless network, from multimedia-specific parameters, receiver display capabilities of one or more receiving devices, and link conditions, wherein the target QoS parameters are configured for implementation in the wireless network to provide quality of experience (QoE) for the multimedia content delivered by the adaptive streaming communications; and
physical-layer circuitry to transmit adaptive streaming communications within the wireless network in accordance with the target QoS parameters.

14. The network communications device of claim 13, the cross-layer adaptation manager providing a Radio Adaptation and QoS engine to determine wireless radio-level adaptation and QoS parameters for the wireless network.

15. The network communications device of claim 13, the cross-layer adaptation manager providing a Network Adaptation and QoS engine to determine network-level adaptation and QoS parameters for the wireless network or a core network operably coupled to the wireless network.

16. The network communications device of claim 13, the cross-layer adaptation manager providing a Real Time Streaming Protocol (RTSP)/Hypertext Transport Protocol (HTTP) Access Client to handle transport-level operations, and establish and manage the RTSP/HTTP transport connections for the wireless network.

17. The network communications device of claim 13, wherein obtaining multimedia-specific parameters includes parsing multimedia content information provided in metadata; and
wherein calculating the target QoS parameters includes determining the target QoS parameters, streaming parameters, transport parameters, network parameters, and radio parameters for the adaptive streaming communication based on the parsed multimedia content information.

18. The network communications device of claim 17, wherein the multimedia content information provided in metadata includes one or both of session description protocol (SDP) or media presentation description (MPD) metadata.

19. The network communications device of claim 13, the cross-layer adaptation manager providing a Media Adaptation Engine to determine codec-level adaptation parameters for the adaptive streaming communication.

20. The network communications device of claim 13, the cross-layer adaptation manager providing a QoE monitor to dynamically measure QoE of the adaptive streaming communication at a receiver display, and determine the target QoS parameters, streaming parameters, transport parameters, network parameters, and radio transmission parameters based on the measured QoE of the adaptive streaming communication at the receiver display.

21. The network communications device of claim 13, wherein one or more peer-to-peer (P2P) connections are established between at least one receiving device and at least one transmitting device via the wireless network in connection with at least one digital transmission of video and audio data signals.

22. A wireless communication device, comprising:
processing-layer circuitry configured to provide a cross-layer adaptation manager for optimizing adaptive streaming across multiple network layers in connection with an adaptive streaming communication transmitted from the wireless communication device, wherein the cross-layer adaptation manager is configured to:
determine target quality of service (QoS) parameters for wireless network implementation based on multimedia-specific parameters, receiver display capabilities of a receiving device, and link conditions, wherein the target QoS parameters provide quality of experience (QoE) for multimedia content delivered by the adaptive streaming communication; and
physical-layer circuitry to transmit the adaptive streaming communication from the wireless communication device to the receiving device via a wireless local area network, in accordance with the target QoS parameters.

23. The wireless communication device of claim 22, the cross-layer adaptation manager further configured to:
adapt the target QoS parameters, bandwidth allocations, transport parameters, and multimedia streaming parameters at application, session, and transport layers of the wireless local area network based on the multimedia-specific parameters, the receiver display capabilities, and the link conditions.

24. The wireless communication device of claim 22, wherein the adaptive streaming communication occurs via a peer-to-peer (P2P) connection between the receiving device and the wireless communication device,
wherein the wireless communication device receives the multimedia content and content-specific application layer parameters of the multimedia content,
wherein the cross-layer adaptation manager adapts the target QoS parameters, transport parameters, and multimedia streaming parameters of the multimedia content for transmission of the multimedia content via the P2P connection, and
wherein the cross-layer adaptation manager manages session parameters for the adaptive streaming communication over the P2P connection.

25. The wireless communication device of claim 24, wherein the P2P connection facilitates a digital transmission of video and audio data signals from the wireless communication device to the receiving device via the wireless local area network.
